(19) United States
(12) Patent Application Publication
(10) Pub. No.: US 2004/0124241 A1
(43) Pub. Date: Jul. 1, 2004

(54) Access control system (ACS)

(76) Inventor: Michael A. Haddad, Gaithersburg, MD (US)

Correspondence Address: MICHAEL HADDAD, 18945 CROSS COUNTRY LANE, GAITHERSBURG, MD, 20879, US

(21) Appl. No.: 10/330,981

(22) Filed: Dec. 30, 2002

(51) Int. Cl. G06K 7/00

(52) U.S. Cl. 235/435

(57) ABSTRACT

The invention relates to the following fields:

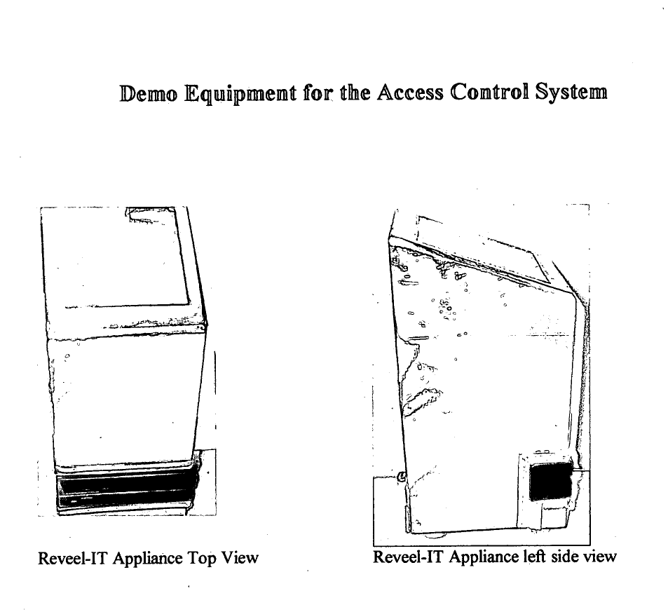

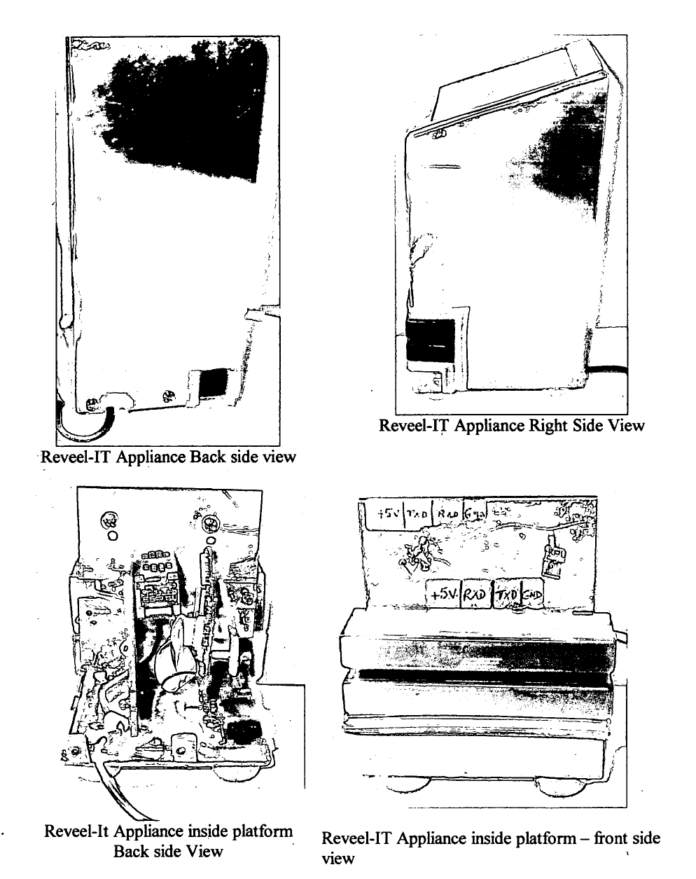

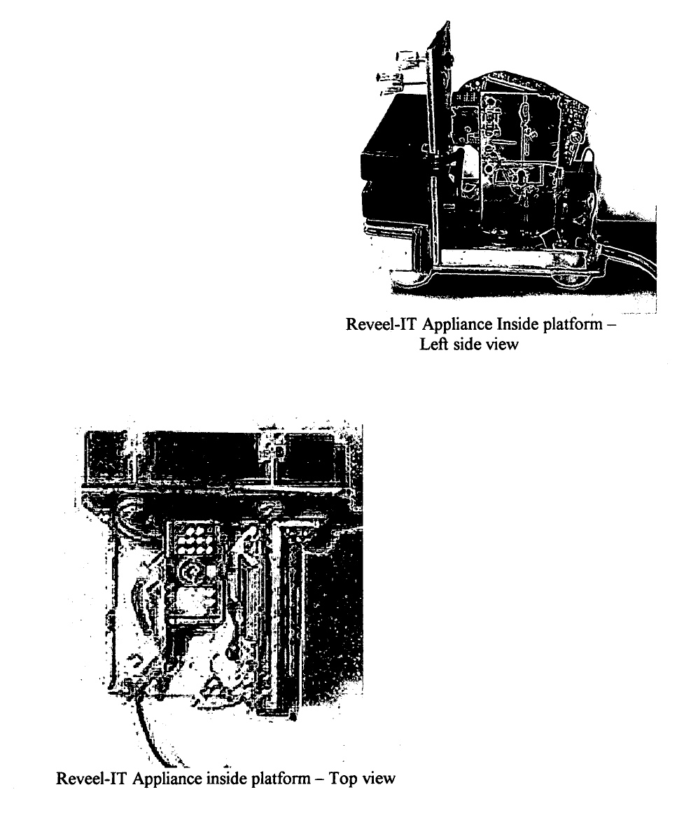

1—High Tech application

2—Security

3—Visitor Identification & control

4—Complying with and supporting all available identification standards in all 50 states.

5—System applicability in small to large office environment and to local, state and federal government offices.

A business system promoting security and control using state of the Art Reveel-IT device.

### REFERENCE TO SEQUENCE LISTING, A TABLE, OR A COMPUTER PROGRAM LISTING COMPACT DISK APPENDIX

The computer programming files that have been designed to control Reveel-IT and a label printer can be found on the CDs included with this patent application.

The different parts of the program are as follow:

1—Form1.cs: is the main program that interfaces with the user and the 2 COM ports. Form1 controls Reveel-IT as well as the printer and responds to the user commands.

2—Form2.cs: is the data collection window that is activated when the system is in maintenance mode.

3—Register.cs: is the program that performs the program registration and licensing.

4—DataCollection.cs: is the program that performs data displaying and collection, employee search, messaging and so on. This program also contains the printing code that prints the badge and also prints a Code39 bar code that contains a VisitorID, on the badge. The visitor sign-out process can be completed using this program-generated barcode.

5—FindRecView.cs: is the program that allows a user or management to search the database records for visitors by name, address, zip code, and also searches by employees.

6—ReportView.cs: is the program that creates reports out of the data collected. The reports are daily, monthly, yearly and by dates.

7—Login.cs: is the program that protects the system from being used by unauthorized personnel. Only System administrators, permitted users, and system support personnel can be logged in to carry certain allowed tasks.

### BACKGROUND OF THE INVENTION

ACS provides increased security control at buildings and protected areas entrances by allowing point of access guards or front desk employees to systematically acquire information and safeguard this information for eventual use in case of security breaches.

The different parts, subject of this utility patent, have been designed to carry on certain tasks:

1—The software program is the controlling body of the system that collects data, saves data, responds to commands, and provides reporting and searching utilities. The program runs on as 486-based PC.

2—A physical device “Reveel-IT” was designed to communicate with the program through two serial ports, UART 15500, COM1 and COM2. Further description of Reveel-IT follows.

Other parts of the systems are used to perform required tasks:

1—A Dymo direct thermal label printer that prints standard badges size 3.5″×2.25″

2—3.5″×2.25 name badges

3—Plastic badge holders with clips or pins

### BRIEF SUMMARY OF THE INVENTION

Currently, industry and government locations that receive outside visitors ask those visitors to write their name and time-in in a guest book that lays on the counter in front of the front desk employee. This notebook is rarely accurate and is seldom used for sign out. In addition, this data collection mechanism is useless and cannot be used to carry on certain security control or certain management tasks.

The proposed system solves this problem in a very efficient manner, while increasing company or government agency control over visitor's records, and at the same time reducing the burden on the visitor by automating the process, and keeping accurate records for further processing.

This is how the process works:

An Access Control System is placed at the front desk.

A Reveel-IT unit is placed at the visitor level.

A printer is placed at the Front desk employee level.

A visitor uses his/her driver's license to swipe it or scan it depending on the driver's license state of issuance. Since different states use different standards in encoding information, Reveel-IT covers all situations as it can read a magnetic stripe such as the ones used in MD, as well as 2-D barcodes such as those found on VA drivers license. Half the states use one technology, the other half using the other. However Reveel-IT solves this problem by presenting a solution that can read information from both. This is a unique solutions and one of this patent claim.

By swiping or reading the drivers license, a visitor data is collected in the program interface.

The front Desk employee selects or searches for the visited employee.

When the sign-in button is clicked, the visitor is registered and an instant badge is created with all the information necessary as, per the example badge included.

A visitorID barcode is also printed on the badge.

When the visit has ended, the visitor can sign out by swiping his driver's license again, or can simply use his/her badge to scan the printed barcode, which signs out the visitor automatically.

The process is so efficient; it takes only 30 seconds from the time the ID is read to the issuance of the badge.

If a driver's license id is not available, a visitor can use his/her credit card, which is also supported by Reveel-IT device. The rest of the process is the same.

The system is further enhanced with a time card reporting system, included with the software that will allow employers to time-in, time-out their employees using Reveel-IT to scan their badges.

### BRIEF DESCRIPTION OF THE SEVERAL VIEWS OF THE DRAWING

The drawing included shows a design for Reveel-IT unit. The unit includes the following hardware:

1—A magnetic strip reader

2—A Symbol imager/scanner unit SE 4200

3—A Symbol Controller board with powerPC chip

4—An internally designed board that converts a Simple Serial Interface (SSI) into a serial interface.

5—The unit may also be equipped with a +5V power supply that could be internal or external to Reveel-IT.

### DETAILED DESCRIPTION OF THE INVENTION

ACS is a new system designed to manage and secure visitor access into a protected facility whether private industry or government. ACS is highly automated and relies on ID with magnetic stripes or 2-D identification barcodes.

Companies use notebooks and ask visitors to manually provide identification information. The system allows an entrance guard with tools that will accomplish the following:

Reading drivers license with PDF417 bar codes by presenting the ID on the top of Reveel-IT (special equipment designed and built for this purpose).

Reading driver's license information with magnetic stripes by swiping the ID at the center of Reveel-IT

Reading Credit cards by swiping card at the center of Reveel-IT

Collecting all possible information about a visitor

Creating a Visitor badge with printed barcode Code 39 showing Visitor ID.

Visitor sign out using a driver license ID or the barcode scanning out of the previously printed badge.

Reporting mechanism and printing reports

Storing the information in a searchable database

Furthermore, planned system features using Reveel-IT:

Scanning & Reading finger prints

Capture and store a picture of the visitor driver's license.

Reading memory cards ID.

ACS Software Process

A visitor that walks into a Lobby will be able to swipe a driver's license, scan a driver's license PDF417 barcodes, or simply swipe a credit card. Credit card capabilities are added in order to allow individuals without driver's license to be identified and be issued a badge.

The system is designed to provide:

Daily reports

Weekly reports

Monthly reports

Yearly reports

Report by date

Search by name, address, or zip code, & by employee

Other reports may be custom designed for a special purpose.

The system collects:

Name

Address Line 1

Address Line 2

City

State

zip

Country

Person or department to visit

ID Type

Gender

Weight

DOB

Height

Time In

Time Out

[image]

All information is obtained automatically using the swipe or scan of a driver's license. System automatically checks for visitor existing records to determine any suspect status.

System allows a front desk operator to search/select an employee to be visited. The sign in button saves the information for future reports and automatically prints a 3.5″×2.25″ badge encoded with a bar code 39 that the visitor can use to sign out upon leaving.

The system interfaces with our proprietary “REVEEL-IT” Device to perform these automated tasks. Support for all 50 states has been provided through “REVEEL-IT”. For those visitors with no driver's license, credit card swipe allows the system to pick up the name and ID and further issue a badge.

Searching capabilities is provided by employee, visitor address, name, or zip code. System provides several other reports: daily, monthly, yearly or by date.

[image]

Further enhancement of the system will include:

Speech recognition to allow a guard or front desk to store messages.

ID picture acquisition and storage

International ID support

Fingerprints reading and recognition

More . . .

Description of “Reveel-IT”

Reveel-IT is device that includes:

A magnetic swipe reader

A high end imager scanner with image capture capabilities

Controller board

Power supply or supply board

Communication capabilities through 2 serial ports COM1 and COM2

The device box is physically designed to incorporate all hardware in a compact way. Extra consideration has been taken to design the top part of the device in order to insure imager engine is reading properly and to avoid light reflection.

The device interior is painted in black.

The device shape may slightly vary, while still taking into consideration all physical parameters of the devices included.

Reveel-IT is unique in its capabilities as it can do all of the following tasks:

1—Read a magnetic stripe with up to 3 tracks

2—Read a 2D barcode

3—Read 1D barcode

4—Read US Postnet code

5—Read Data Matrix code

6—Read Maxicode,

7—Take pictures and communicate binary data to the host

The controller board acts as a decoder with a PowerPC to process the information before transmitting it to the host.

The subject of protection here is the combination capabilities of REVEEL-IT that will allow reading of any driver license from all 50 states.

The hardware included is mostly manufactured by third party vendors. However, our add-on design includes electronics to interface between simple serial Technology and PC serial technology UART, in addition to incorporating a power supply to the device.

The device will be set in presentation mode allowing an ID to be read upon presentation to the top Window.

The top Window is designed with a specific dimension to make easy to place an ID for reading.

The top window is made of acrylic with anti scratch coating and a thickness of almost 4 mm.

Since the final product appearance may vary, no specific dimensions are included in this application. However, the imager device is located at about 5 inches from the top window and that distance may have to stay constant unless a newly designed imager is included that can manipulate distance and focus automatically.

For the purpose of this provisional application, some dimensions are given here that describe the demo unit, of which pictures are included:

| | |
|---|---|
| Front height: | 22 mm |
| Back height: | 26 mm |
| Front & back Width: | 11 mm |
| Sides width: | 15 mm |

The serial board is accessed through an opening at the back of REVEEL-IT and is seated in the inside right side (looking from front.

The controller board is affixed against the front wall and under the swipe. The swipe is embedded within the box with a front opening of 5 mm to allow enough clearance to swipe a card with magnetic stripe.

The imager is affixed against the right wall when looking at the front.

Inventor claims protection for the following invention:

1- Reveel-IT Appliance:
a. Support of drivers license magnetic stripe reading technology, drivers license 2D barcoding technology in one compact box.
b. Support of drivers license magnetic stripe reading technology, drivers license 2D barcoding technology and credit card reading technology in one compact box.

2- Software:
a. Drivers license 2D barcode and drivers license magnetic stripe decoding software
b. Visitor records management, reporting and tracking system

3- Automatic printing of barcoded badges with visitor photo to be used for signing in and signing out visitors using the above appliance and software.
